(19) United States
(12) Patent Application Publication
(10) Pub. No.: US 2013/0036882 A1
(43) Pub. Date: Feb. 14, 2013

(54) SYSTEM DEVICE AND METHOD OF USING A PROPORTIONAL CUTTING DEVICE TO CUT EQUAL SIZE SLICES OF PIZZA

(71) Applicants: Greg Getzinger, Hudson, OH (US); Andrew R. Spriegel, Hudson, OH (US)

(72) Inventors: Greg Getzinger, Hudson, OH (US); Andrew R. Spriegel, Hudson, OH (US)

(73) Assignee: NuVoGrand, LLC, Hudson, OH (US)

(21) Appl. No.: 13/555,942

(22) Filed: Jul. 23, 2012

Related U.S. Application Data
(60) Provisional application No. 61/511,723, filed on Jul. 26, 2011.

(51) Int. Cl. B26B 29/06; B26D 7/32; B26D 3/24

(52) U.S. Cl. 83/23; 269/295; 30/289

(57) ABSTRACT

A system and method of utilizing a food cutting guide that has a base having a circular first and circular second planar surface. The guide has a plurality of grooves formed in at least one of the planar surfaces and at least one centering guide formed on the at least one of the planar surfaces to facilitate cutting equal size slices and/or sections of food.

### PRIORITY CLAIM

This application claims priority to U.S. Provisional Application Ser. No. 61/511,723 filed Jul. 26, 2011, entitled “SYSTEM DEVICE AND METHOD OF USING A PROPORTIONAL CUTTING DEVICE TO CUT EQUAL SIZE SLICES OF PIZZA”.

### FIELD OF THE INVENTION

The invention relates generally to a proportional cutting device for cutting pizzas, pies, cakes, and the like into equal proportions and more specifically to a system and method of using a proportional cutting device to cut equal size slices of pizza.

### BACKGROUND OF THE INVENTION

Public and private schools, sports teams, booster clubs, children party centers, hospitals, nursing homes and institutions all have a need for pizzas cut into equal size slices for lunch programs, meals, fund raisers, and the like. When there are equal slices, there are no odd shapes or undersized or oversized slices. Thus, there is a need for a pizza board to ensure that different size diameter pizzas (e.g., an 8 or 14 inch diameter pizza) can be cut into equal size slices.

Various prior art attempts have been developed which include products for cutting pizza and food items into equal slices. Some of these have focused on the board that holds the pizza, while others have focused on the devices for cutting the pizzas. However, all of those prior art attempts have various limitations and disadvantages, and the present invention provides improvements over these prior art devices.

Further, nutritional studies indicate that many popular foods eaten in the US are wedge-shaped (e.g., pizza, cakes, and pies), and these foods and portion sizes affect the amount of saturated fat and sugar that are consumed and that they are associated with degenerative health conditions. Thus, it is important that amounts of wedge-shaped foods reported in food consumption surveys be as accurate as possible (See e.g., Journal of the American Dietetic Association, Mar. 14, 2006). However, the standard techniques for measuring portion sizes of wedge shaped foods are often inaccurate and consequently the invention discussed herein can be used to eliminate those issues.

U.S. Pat. No. 4,100,676 to Ferguson teaches a board with rectangular score lines or channels designed to achieve equal slices and this device is shown in prior art FIGS. 1-3. The pizza cutting board base 10 has two oppositely facing flat planar surfaces. Each of the flat surfaces has straight slots 40, 42, 44 and 46 formed on the board which intersect to subdivide the surface into a plurality of segments. A cutting instrument is drawn through each slot to cut a superimposed flat object, such as a pizza, into pieces. However, the Ferguson patent suffers from numerous limitations, because the slots as shown in FIG. 3 are likely to result in premature wear. The slots shown in FIGS. 2 and 3 are perpendicular to one another on the board surface and therefore if the cutting tool is not held perpendicular to the plane of the flat board, the cutting tool can cut or slice off the edge of the square groove and result in debris which can become attached to or mixed with the pizza slices. Further, the square slots are difficult to clean in the corners and therefore food particles and debris can become trapped in the slots. In addition, there is no indication on the pizza board to indicate that the pizza center is properly centered with a slot center and therefore the slices can be cut unequally when the pizza is not properly centered on the board with respect to the slot center.

U.S. Pat. No. 2,906,020 issued Sep. 29, 1959 to Welsh teaches a prior art pizza cutting device having a segmented base with a unitary cutter having blades matching the dividing partitions in the base. The device shown in prior art FIG. 4 has numerous deficiencies. A pizza placed on the base is cut with one pass of the cutter through the pizza and into the base. However, the Welsh device is complicated, difficult to clean, bulky and expensive. The fact that the device is stationary makes the pizza cutter difficult to clean in between cutting different variety pizzas. The Welsh cutter does not allow for easy cleaning of the cutter in between cutting pizzas because of its size and weight. The Welsh cutter would be used primarily in an area where a large number of pizzas would be cut, such as in a pizza restaurant, a pizza shop, etc. and must be disassembled for cleaning, as well as requiring the more complicated and difficult transfer of the pizza from the base to a carrying or transfer device.

FIGS. 5 and 6 illustrate yet another prior art cutting device, namely that taught by U.S. Pat. No. 6,557,260 issued to Morris, May 6, 2003. The Morris device consists of a series of blades that are spaced equidistant around a rim and originating from a central axis. The Morris device is not unlike a “cookie cutter”, but it is for pizzas. However, the blades have difficulty cutting the pizza because the cutting blades all cut at one time. It is difficult to apply a large cutting force at any given point on the blades because the applied force on the pizza is distributed across all of the blades. In addition, the Morris pizza cutter is difficult to clean because many areas of the device are difficult to get to thereby making cleaning challenging and the device is expensive.

Notwithstanding these prior art devices for cutting equal pizza slices and related applications, there continues to be a need for a low cost, easy to operate system and method, that limits or prevents wear on the device, is easy to clean between uses, that can be used to cut various diameter pizzas, rectangular pizzas, and the like into equal slices, that properly centers the circular and/or rectangular pizza, for example, at the center of the cutting board, that produces a clean cut through the pizza, and the like.

### SUMMARY OF THE INVENTION

Accordingly, the present invention overcomes the limitations of the prior art by providing a unique and useful cutting board comprising a system device of grooves and devices and method for cutting equal size wedge or pie shaped portions, rectangular shaped, diamond shaped, and the like, slices of pizza, for example. The cutting board of the present invention is such that it is simple to construct, inexpensive to make and to use, easy to clean between uses, allows the centering of the pizza on the pizza board and many other advantages mentioned below.

Consequently, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

It is an object of the present invention to provide a pizza proportional cutting device and method that is easy to clean the cutting device between uses and is dishwasher safe.

It is a further object of this invention to provide a pizza proportional cutting device that is easy to manufacture utilizing food-safe and/or eco-friendly materials.

It is an object of the present invention to provide a proportional cutting device and method that allows the user to cut approximately equal size slices of pizza, pies, cakes and the like.

It is yet another object of this invention to provide cutting device that comprises plastic, metal, composite, wooden, a combination thereof, and the like, wherein the proportional cutting device material reduces the premature wear of the proportional cutting device slots.

It is yet a further object of the present invention to align the center of varying size pizzas with a center marked on a proportional cutting device.

It is an additional object of the invention that a proportional cutting device be used in conjunction with a rocker type two handled knife and/or a pizza rolling cutter and/or a knife.

It is another embodiment of the present invention to provide a proportional cutting device with one or more handles for assisting a user in lifting the proportional cutting device.

It is an additional object of the invention that a proportional cutting device be used in conjunction with a pizza cutting wheel.

It is another object of the present invention to provide a proportional cutting device system that allows the user to cut approximately equal size food items that are pie shaped, triangular, rectangular and other shaped pieces of cake, pizza, pie and other suitable foods.

It is another object of the present invention to provide a proportional cutting device system that allows the user to cut predetermined size food items that are pie shaped, triangular, rectangular and other shaped pieces of cake, pizza, pie and other suitable foods that are not all equal slices.

It is another embodiment of the present invention to provide a proportional cutting device with one or more handles for assisting the user to lift the pizza board.

In another embodiment of the present invention, the portion of the device where the cutting grooves are located could be the thickest portion of the board wherein the flanged portion between the cutting grove portions can have material removed so that the pizza remains relatively flat, such as honeycombed, grooves and the like and can be easily slid off the device.

It is another embodiment of the present invention thru-holes (i.e., lightening holes), and the like can be formed by removing material or molding the device to lighten the board for the end user. In addition, a very lightweight composite, such as an aluminum honeycomb sandwiched between two layers of material (e.g., plastic, composite, bamboo, etc.) could be utilized and all such devices are encompassed in the scope of this invention.

### BRIEF DESCRIPTION OF THE DRAWINGS

FIGS. 1-3 illustrate a prior art pizza cutting board having straight slots that are difficult to clean, can prematurely wear because of the slot shape, that does not have centering circles, knife guides and that suffers from other deficiencies;

FIG. 4 illustrates a prior art pizza cutter with a segmented base and a unitary cutter having a blade matching the dividing partitions in the base so that a pizza placed on the base is cut with one pass of the cutter through the pizza and into the base, which is complicated, difficult to clean, bulky and expensive;

FIGS. 5 and 6 illustrate a prior art series of blades that are provided equidistant around a rim and originating from a central axis, that is difficult to use, difficult to clean and that suffers from numerous deficiencies mentioned supra;

FIG. 7 illustrates an equal slice pizza proportional cutting device according to an embodiment of the present invention that can comprise slots on one side and/or both sides of the device;

FIG. 8 is a cross-sectional view of a proportional cutting device thru-slot according to yet another embodiment of the invention;

FIG. 9 is yet another embodiment of a cross-sectional view of a thru-slot utilized to minimize and/or eliminate premature wear of a proportional cutting device according to another embodiment of the invention;

FIG. 10 is a side view of a two handle rocker cutting tool that can be used in conjunction with the proportional cutting device according to another embodiment of the invention;

FIG. 11 is a cross-sectional side view of a compound angle slot that can be used in conjunction with the proportional cutting device according to an embodiment of the invention;

FIG. 12 is a cross-sectional side view of a curvilinear slot that can be used in conjunction with the proportional cutting device according to an embodiment of the invention;

FIG. 13 is a top view of a slot design where a pizza may be cut into two different sizes portions according to yet another embodiment of the invention;

FIG. 14 is a top view of a rectangular proportional cutting device that can be used in conjunction with the proportional cutting device according to yet another embodiment of the invention;

FIGS. 15 and 16 are top views of approximately rectangular proportional cutting devices according to yet another embodiment of the invention;

FIG. 17 is a top view of an approximately rectangular proportional cutting device that can be used in conjunction with the proportional cutting device to multiple pizzas along one slot according to an embodiment of the invention;

FIG. 18 is a perspective view of a plastic cake holder that would be used, for example, in a supermarket to keep a cake fresh according to yet another embodiment of the invention; and

FIG. 19 is a flow diagram illustrating an exemplary method of cutting equal slices of pizza utilizing a proportional cutting device according to yet another embodiment of the invention.

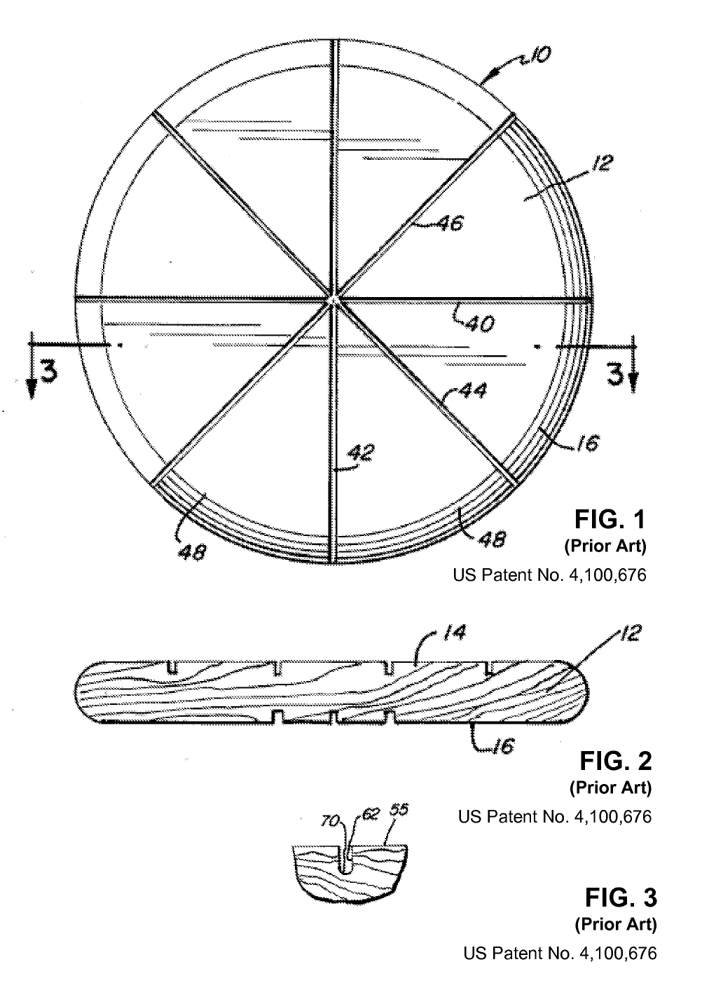

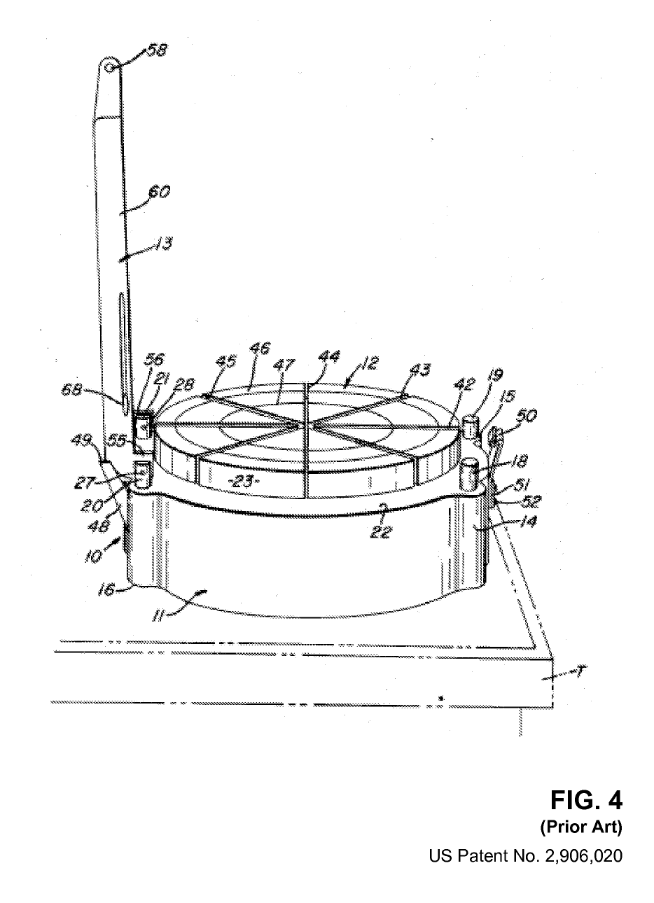

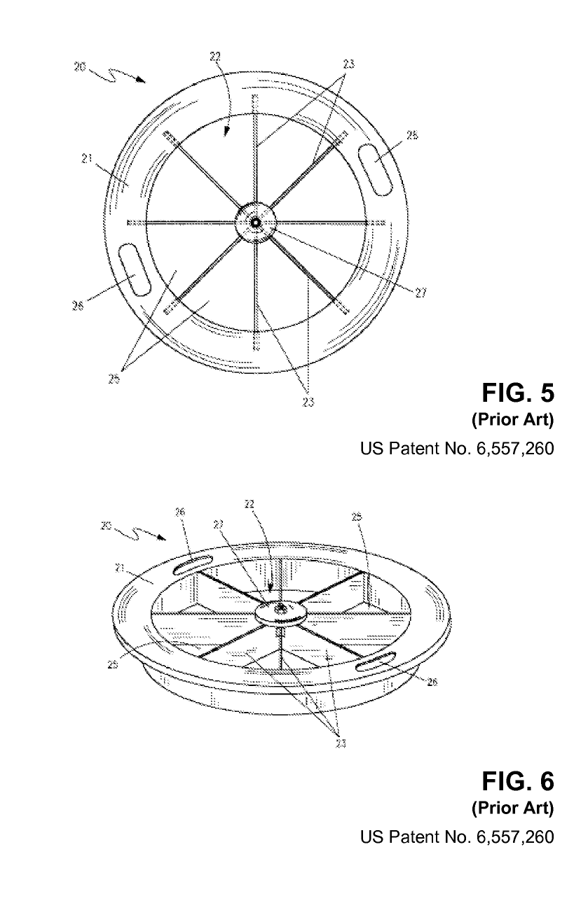

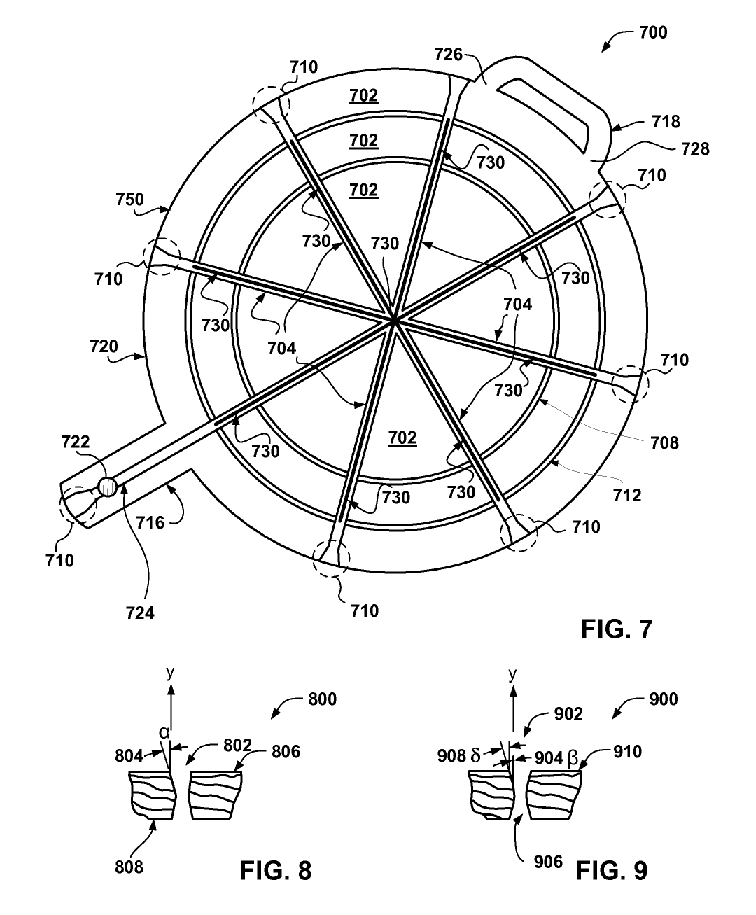

### DETAILED DESCRIPTION OF THE INVENTION

One or more implementations of the present invention will now be described with reference to the attached drawings, wherein like reference numerals are used to refer to like elements throughout. The invention relates generally to a proportional cutting device for cutting pizzas, pies, cakes, and suitable foods into equal proportions. The invention is basically a cutting board having a system of grooves and will be described with respect to pizza; however, it includes any other food items such as pies, cakes, tortillas, quesadillas, and the like that are known by those of skill in the art. The design of the grooves in combination with the use of a device groove facilitates the cutting and results in equal slices being easily produced.

The cutting board of the present invention can be used with a variety of cutting devices, and so is not limited to any particular cutting device. The board also can be used as a pizza paddle, and so does not require a user to have separate pizza paddles and cutting boards.

As seen in FIG. 7, in one embodiment of the present invention comprises an equal slice proportional device 700 with a circular board body 720, although as discussed herein the device 700 can comprise other shapes. The equal slice proportional device 700 having a principal handle 716 and a supplemental handle 718. The body 720 has a plurality of slots/grooves 704 and complete thru-cuts 730 to facilitate the cutting of the pizza (for example) and a guide groove 724 which is placed in the principal handle 716 to facilitate the beginning of the cutting process which leads to the equal portioning of a food item, in this example pizza. The principle handle 716 is needed for lifting the equal slice proportional device 700 and a pizza, for example and sliding it into the shipping and/or pizza box, a tray and the like. Without a handle the process would be very tedious requiring a spatula or some other instrument or technique to make the transfer.

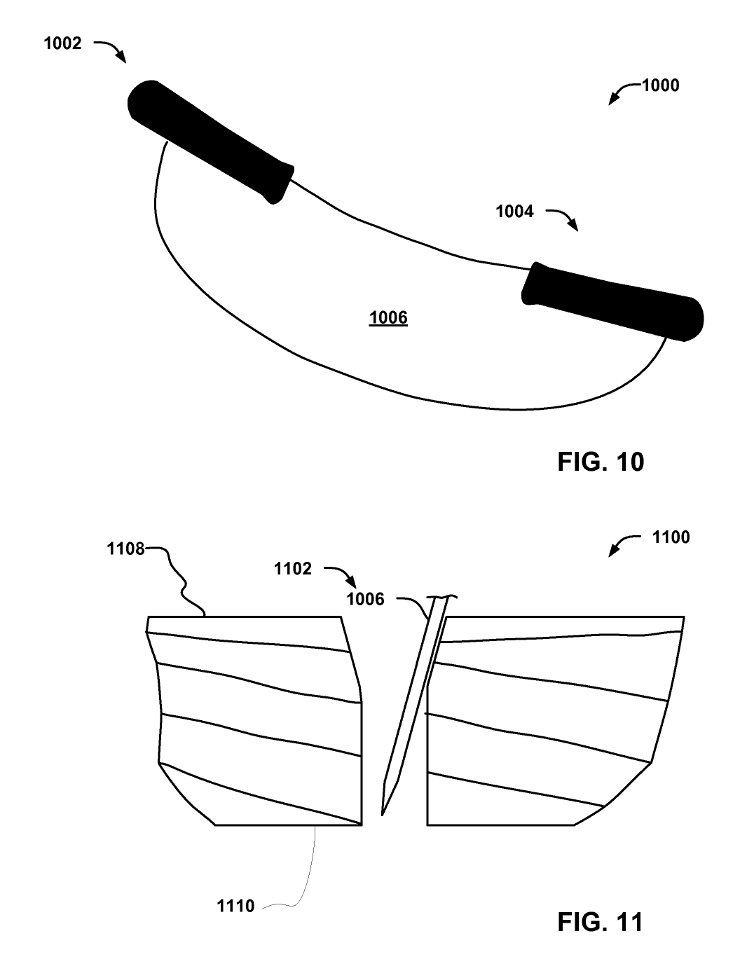

FIG. 7 illustrates an additional advantage of having complete thru-cuts 730 where the thru-cuts 730 pass completely through the device 700. This allows, for example, a two handle knife 1000 with a blade 1006 (FIG. 10 or a roller knife, not shown) to pass completely through the thru-cuts 730 providing greater stability than a groove that does not pass all the way through the device 700. Handles 1002 and 1004 are used to provide greater stability to the knife 1000.

In the one embodiment illustrated in FIG. 7, a pizza can be placed on a first planar surface 702 of the proportional cutting device 700 (wherein the device is placed on a cutting surface, for example) and a cutting tool not shown can be used to slice the pizza into equal pie-shaped segments as desired. The cutting tool can be, for example, a handle held pizza cutting wheel, a knife, a multiple handle rocker pizza blade, and the like. The beveled slots or grooves 704, 708, 712, and 724, for example, are formed, cut, routed, and the like, into the first planar surface 702 of the device 700 to allow a cutting tool to cut through the pizza. Circular centering slots/marks 708 and 712 allow a user to center a pizza on the first planar surface 702 so that a pizza center and a device center 730 are properly aligned. The circular centering slots 708 and 712 are slightly larger in diameter than the diameter of the pizza to be cut. For example, if the pizza to be cut is 8 inches in diameter the circular centering slot may be approximately 8.25 inches in diameter, for example. Once sliced, the pizza may be served on the device 700 or slid off onto a serving plate, platter, tray, cardboard delivery box or the like. Although the circumferential slots 708, 712 are illustrated as being continuous, dashed or interrupted circumferential slots can be formed in the board to properly center the pizza. In addition, the centering slots can be rectangular, oval, triangular, and any shape known by one of skill in the art. In addition, both sides of various boards can include grooves and/or cut-thru slots on each side of the both to cut different numbers of portions.

In addition, though not shown, letters or numbers can be cut, laser etched, and the like to indicate the diameter size in inches, millimeters, etc., at that location, for example. In addition, directions, recipes, artwork, cooking instructions, quotes, messages, individual names, company logos, and the like, can be cut, laser etched, burned, etc. into the first planar surface 702, or a second planar surface (not shown) of the device 700. Also, the slots could be replaced by parallel ridges, elevated guides, and the like, and fall within the scope of this invention.

The inventors recognized that prior art pizza boards had slotted grooves that intersected a central point on the pizza boards; however it was still possible to cut unequal slices of pizza, if the pizza center is not properly aligned with respect to the board's center, which is difficult to do. Therefore, by adding the concentric circles mentioned supra, the inventors can ensure that the pizza is properly centered in order to cut equal sections of pizza and provide the proportioning suggested for dietary control. In addition, the device 700 can be custom made to the buyer's specification comprising the number of pizza sizes, number of slices, board material, board thickness, groove dimension and the like, which is a tremendous advantage over the prior art.

In this embodiment, the device 700 is approximately circular in shape and may be constructed from a variety of materials comprising wood, such as ash, hickory, oak, walnut, maple and purple heartwood, chestnut, cherry; plastic, porcelain, metal, stone, wood composite materials, bamboo, glass, recycled paper composite, plastic composite materials, food safe materials, NSF approved materials and the like. The device 700 can be manufactured utilizing a variety of techniques that include CNC machining, routing, injection molding, rotational molding, blow molding, and the like.

The device 700 has a pair of substantially flat planar surfaces 702 (second side not shown) on each side with the first planar face 702 and a second planar face (not shown) parallel to the first planar face 702. Although the device 700 is described with parallel faces the inventors contemplated non-parallel planar surfaces and such embodiments are considered part of this invention so that the upper facing surface is at an angle when the device is sitting flat on a table. The diameter of the device 700 is sufficiently large to accommodate the pizza to be cut or proportioned. For example, the device 700 may be large enough to accommodate pizzas ranging from four to sixteen inches in diameter, or larger. In addition, slots, markings and the like can be made on one or both planar surfaces, and the markings, slots and the like, can be the same or different on either planar surface. In other words, a first planar surface 702 can be used to cut eight approximately equal slices whereas the second planar surface can be used to cut approximately ten equal slices.

The device 700 is sufficiently thick (e.g., ¼, ⅜ and ½ inches thick) so that the device 700 remains substantially rigid after the centering slots/grooves 708 and 712 and the cutting grooves, 704 and 724 or complete thru-cuts 730 are created in the first planar surface 702 and/or cutting grooves are created in the second planar surface (not shown) of the device 700. The device 700 shown in FIG. 7 is substantially uniform, however, the device 700 of varying thickness designed to reduce weight, material costs, and the like would still be within the scope of the invention. In other words, the portion of the device 700 where the cutting grooves are located could be the thickest portion of the board wherein the flanged portion between the cutting grove portions can have material removed so that the pizza remains relatively flat, such as honeycombed, grooves and the like and can be easily slid off the device 700. In addition, thru-holes (i.e., lightening holes), and the like can be formed by removing material or molding the device to lighten the board for the end user. In addition, a very lightweight composite, such as an aluminum honeycomb sandwiched between two layers of material (e.g., plastic, composite, bamboo, etc.) could be utilized and all such devices are encompassed in the scope of this invention.

In the embodiment shown in FIG. 7, the handle 716 is approximately rectangular in shape that can be utilized as a hand grip and an approximately semicircular handle 718 can be offset from the handle 716 and the handle 718 connects to the device 700 in two places 726 and 728. The handle 716 and the handle 718 can be offset (in other words not located on the same line bisecting the circle) so they are not 180 degrees apart from the intersection's center 730, as shown, to allow the user to balance the device 700 holding a pizza, for example, and thus prevent tipping. However, the devices may include a plurality of handles in a variety of shapes and sizes designed to support the weight of the pizza and still be within the scope of the invention. The principal and secondary handles 716, 718 may be continuous with the device 702 as shown in FIG. 7, or they may be detachable and fastened with any known commercial fastening technique known to those skilled in the art such as glue, joints, fasteners, screws, nails, dowels, and the like. The principal and secondary handles 716, 718 may also be made of a different material than the device 702 and remain within the scope of the invention. For example, the device could be maple and the first handle black walnut. In addition, the device 702 can be a lamination of various materials comprising, metal, wood, plastic, composites, bamboo and the like.

The device 700 illustrated in FIG. 7 is further defined by the cutting slots or cutting grooves 704, 724 that each bisect the approximately circular surface of the first planar surface 702 with an approximate outer circumference 750. FIG. 7 illustrates an additional advantage of having complete thru-cuts 730. The slots 704, 724 extend into the device 700 a sufficient depth or completely through the device 700, for example one eighth of an inch or all the way through the device 700, to allow the cutting tool to completely cut through the pizza placed on the first planar surface 702. FIG. 7 shows four of the slots 704 and 724 to cut eight approximately equal pieces of pizza but is not intended to be a limit on a number of the slots formed in the device 700. The slot 724 bisects the first planar surface 702 running longitudinally through a center of the handle 716. In addition, the handle 716 has a thru-hole 722 for hanging the device from a hook, for example or for attaching a cord, leather strap, etc.

The inventors recognized that by extending the slot 724 onto the handle 716 it would aid in making the initial bisecting cut of the pizza because the cutting tool can be easily located on handle slot 724. The initial slot 724 non-fixedly holds the pizza to the first planar surface 702 because the pizza forced into the slot 724 during the cutting process prevents from the pizza from rotating during subsequent cutting operations. In addition, by having the slot 724 extend into the handle 716 it is easier to locate and begin the cutting process thereby speeding up the process when compared other prior art devices.

FIG. 8 further describe the thru-slots 730 illustrated in FIG. 7, with another embodiment 800 wherein a thru-slot 802 with a beveled edge where the angle a 804 is, for example, approximately between 5 and 10 degrees at a top and the bottom of the thru-slot 802 is completely through a first planar surface 806 and a second planar surface 808.

FIG. 9 illustrates yet another embodiment 900 of a slot 902 as having a compound angle with angle β904, located adjacent to the bottom of the slot 906, and angle γ908, closest to the first planar surface 910, measured from the vertical y axis, as shown, where the total combined angle is between 5 and 15 degrees, for example. The scope of this invention includes slots of other shapes and sizes including a continuous curve, various arcs, compound angles, concave shapes and the like. The compound slot 1102 (FIG. 11) illustrates how the knife blade 1106 (FIGS. 10 and 11) is directed through the bottom of the slot 1102 and away from the side edges thereby reducing he wear on the device 1100. The slot 1102 passes through the device 1100 from a top surface 1108 to a bottom surface 1110.

FIG. 10 illustrates a prior art two handle 1002, 1004 rocker cutting tool 1000 that can be used in conjunction with the proportional cutting device 700 mentioned supra. The inventors recognized that by using the cutting tool 1000 with a curvilinear blade that when the cutting tool blade 1006 comes into contact with the pizza it does so with a tangential or point load that is a larger load that is applied to the pizza at any given cutting location to cut the slice completely through, as opposed to some of the prior art devices mentioned supra. In addition, the inventors recognized that by utilizing a compound angle slot 1102, as shown in FIG. 11, with a complete cut-thru slot 1102 that the cutting blade 1006 is directed away from the edge thereby minimizing and/or eliminating excessive wear on the cutting device 700.

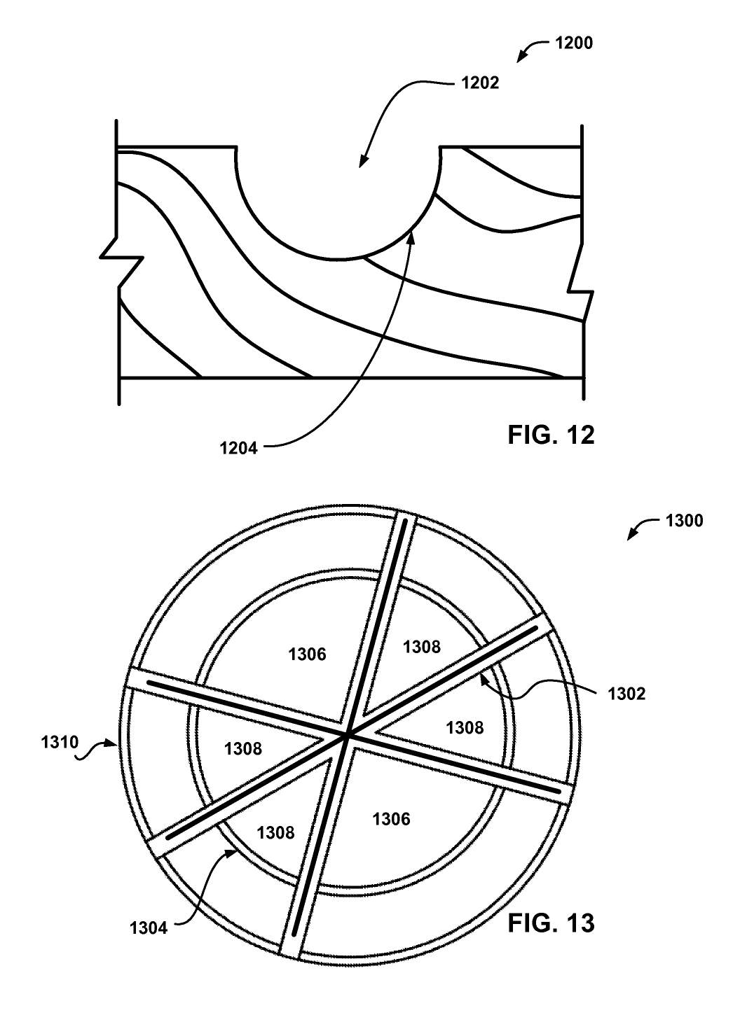

FIG. 12 illustrates yet another embodiment of a slot 1202 wherein the slot 1202 has a curvilinear surface 1204. Routing, cutting and making slots of various sizes and shapes are well-known by those of skill in the art and all such sizes and shapes are contemplated and part of the invention.

For example, another embodiment 1300 illustrated in FIG. 13 is a slot design where a pizza may be cut into two different equal sizes portions 1306 and 1308. This design embodiment allows a pizza to be sliced into two of the larger size portions 1306 as well as four of the smaller size portions 1308. Any combination of equal and/or non-equal size sliced portions is within the scope of this invention. Additionally, the scope of this invention includes both the device 700 utilizing slots 1302 on only the first planar surface 702 or where identical or different patterns of slots and designs are included on the first and second planar surfaces of the device 700. In addition, another embodiment includes cake plates, cake serving platters and pie serving platters, comprising porcelain, plastic, metal and the like with grooves formed in the plates/platters/serving containers, for example to facilitate easy cutting of the plates and platters.

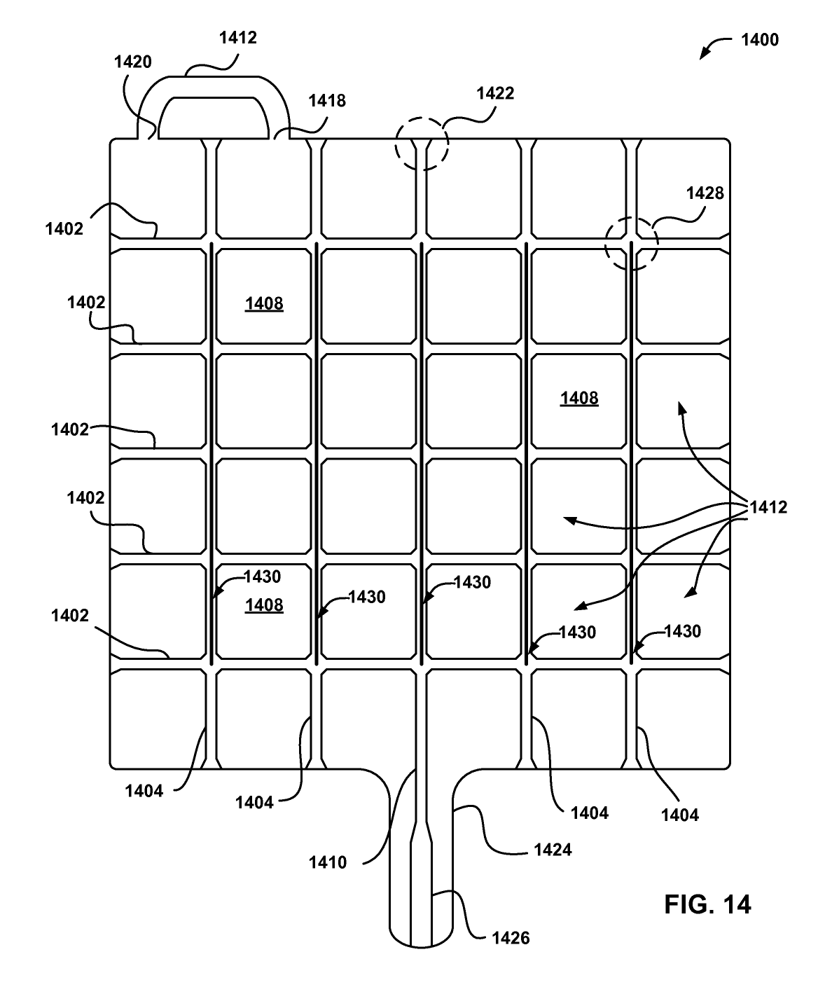

FIG. 14 illustrates an approximately rectangular design where a first planar surface 1408, has a plurality of slots 1402, 1404 and 1410 in the first planar surface 1408 wherein the plurality of slots 1402 and 1404/1410 are substantially perpendicular to each other and the parallel plurality of slots 1402 and/or 1404/1410 are equally spaced apart. The plurality of slots 1402, 1404 and 1410 allows the user to subdivide the pizza into a plurality of substantially equal-sized square shaped pizza slices 1412. For example, the slots 1402, 1404 and 1410 may be cut into the first planar surface 1408 at, for example, four inch intervals creating portions that are four inch square. While this embodiment teaches this design, the scope of the invention is not limited to parallel and perpendicular slots of equal spacing. Any desirable slot design may be created in the first planar surface 1408 of any shaped device such as other geometric or decorative shapes including diamonds, triangles, rectangles, and the like. Additionally, the shape of the proportional cutting device may be circular, square, rectangular, irregular shapes or any other shape desirable to a user. A bevel 1422 can be cut, routed and the like into the beginning of the slots 1402 and 1404 to guide the cutting tool more easily into the slots 1402 and 1404. In addition, an elongated beveled slot 1426 can be formed into a first handle 1424 so that the cutting tool is more easily guided toward the pizza, for example thereby causing less or eliminated premature wear on the device 1400. A second handle 1412 can be formed as part of the device 1400 attaching to the device 1400 at a first location 1420 and a second location 1418, for example. In addition, a complete cut-thru slot 1430 can be created that totally cuts through the device 1499.

FIG. 14 illustrates an additional advantage of having complete thru-cuts 1430 where the thru-cuts 1430 pass completely through the device 1400. This allows a two handle knife blade 1006 (FIG. 10) to pass completely through the thru-cuts 1430.

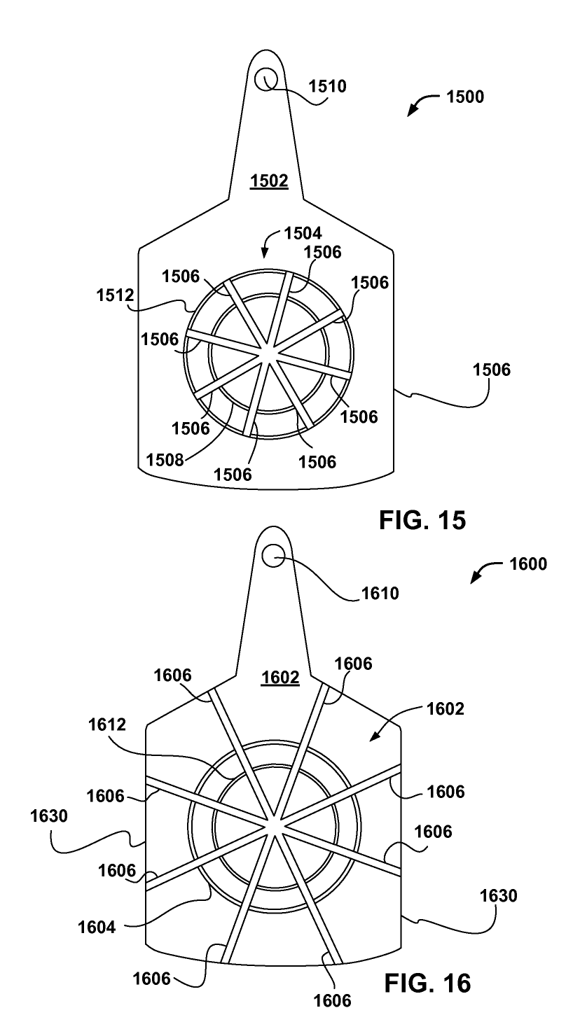

In yet another embodiment of the invention a proportional cutting device 1500 as shown in FIG. 15, a first planar surface 1502 may include an inset or routed portion 1504 for a product to be proportioned that is of a different shape, size or both than the entire device 1500. For example, the first planar face 1502 could be rectangular in shape with a smaller inset 1504 in the shape of a circle that is located well within an outer surface 1506. In other words the cutting portion is within the device 1500. Various slots 1506 and circular centering slots 1508 and 1512 are illustrated in FIG. 15 and are similar to those described supra. The device 1500 can include an optional through-hole for allowing the board to be hung on a nail, hook and the like.

In another embodiment of the invention a proportional cutting device 1600 is shown in FIG. 16, where a first planar surface 1602 may include an inset or routed portion 1604 for a product to be proportioned that is of a different shape, size or both than the entire device 1600. For example, the first planar face 1602 could be rectangular in shape with a smaller inset 1604 in the shape of a circle that is located well within an outer surface 1630. In other words the cutting portion is within the device 1600. However, the slots 1606 extent to the outer surface of the device 1600 and circular centering slots 1608 and 1612 are illustrated in FIG. 16 and are similar to those described supra. The device 1600 can include an optional through-hole for allowing the board to be hung on a nail, hook and the like. In addition, separate cutting devices (e.g., similar to puzzle pieces) that interlock are contemplated, wherein the devices after interlocking can form continuous slots so that pizza and other food items mentioned supra and be cut continuously from one device to another.

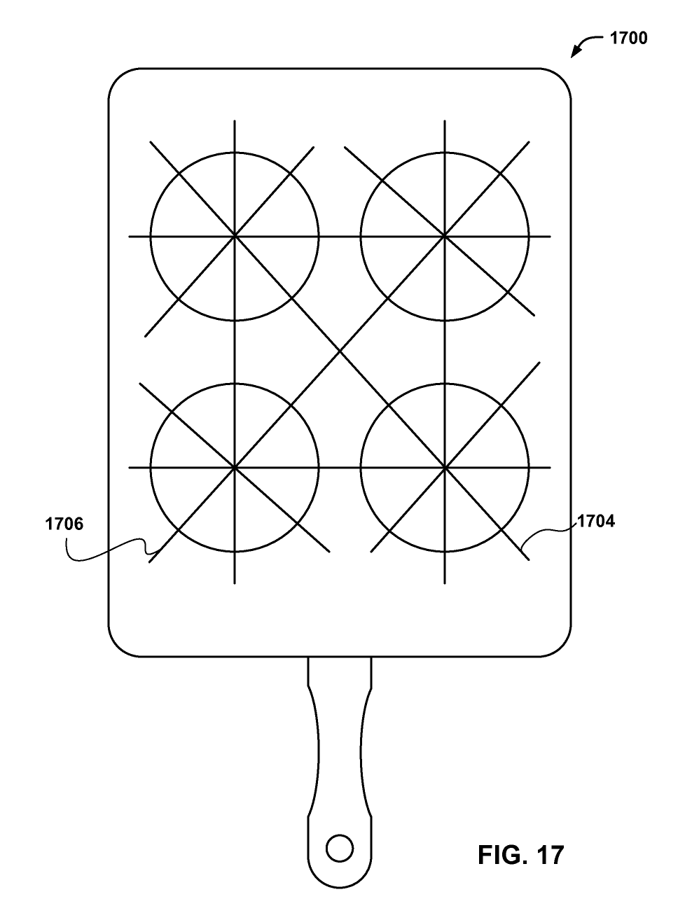

In another embodiment of the invention a proportional cutting device 1700 may also be large enough to accommodate more than one pizza or size pizza, where multiple pizzas can be cut along a single groove 1704 and 1706 as shown in FIG. 17. Although the first planar surface 1702 in FIG. 17 is approximately rectangular, the scope of this invention encompasses all other geometric shapes such as a circular, oval, trapezoid, and the like, in addition to any other desirable shapes such as a horse, a truck, a car, a decorative holiday shape, etc.

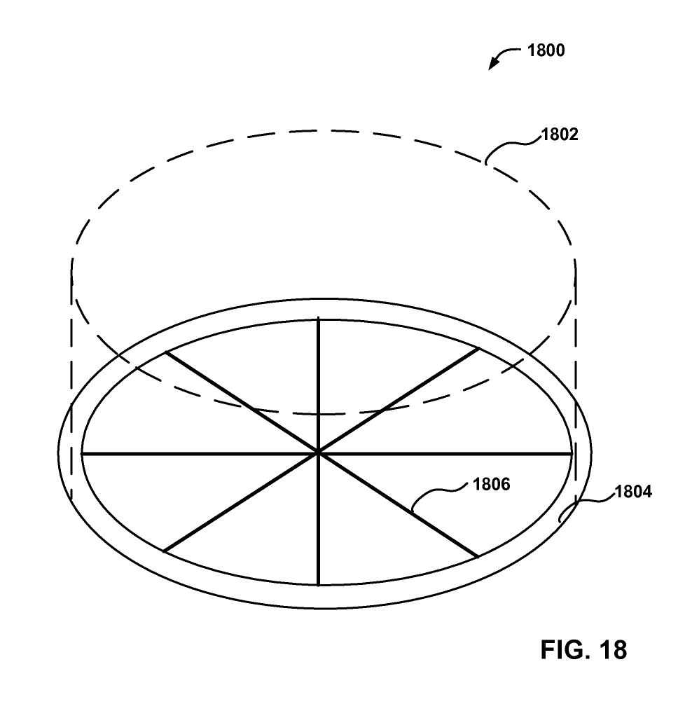

FIG. 18 illustrates a pre-formed enclosure 1800 that comprises an optional top 1802 and a grooved based 1804. The optional top 1802 and the grooved based 1804 can comprise composites, plastics, metals, and the like. The number of grooves 1806 can vary comprising 4, 6, 8, etc. The shape of the grooves can vary comprising v shaped grooves, thru-cuts and the like. In addition, one skilled in the art can easily form or manufacture grooves in containers comprising pizza boxes, and the like. The pre-formed enclosure 1800 can be utilized with a knife, for example, as described in FIG. 7.

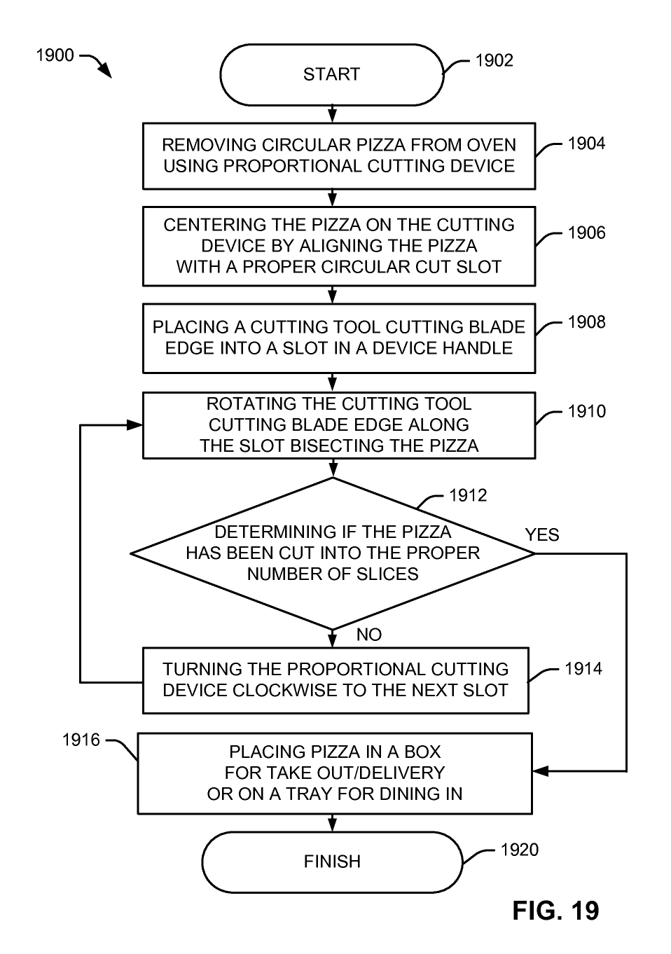

Illustrated in FIG. 19 is an exemplary method 1900 for cutting a pizza into approximately equal size slices according to one or more aspects of the present invention. The method 1900 will be described with respect to FIGS. 7, 10 and 19. Referring now to FIG. 19, the exemplary method 1900 is illustrated which may be advantageously employed in association with a pizza, however the method is not limited to pizza but applies to cakes, pies and other suitable food items. The method 1900 begins at 1902, wherein at 1904 the pizza is removed from an oven utilizing a proportional cutting device 700 (FIG. 7) by sliding the device 700 under the pizza and onto the first planar surface 702, for example. The removal of pizzas from an oven is well known by those of ordinary skill in the art. This would also apply to foods comprising pizza, cake, and others and it can comprise, for example, the foods utilizing containers comprising the containers/devices shown in FIGS. 13, 14, 15, 16, 17 and 18. At 1904, as illustrated and described in greater detail hereinafter the pizza may be centered with respect to the slots 704 and 724 via circular centering slots 708. For example, the pizza can be positioned for cutting using a cutting tool 1000 (FIG. 10) or handling utensil.

The method 1900 proceeds to 1906, whereat the cutting tool cutting blade edge 1006 (FIG. 10) is placed into the wider angled guide 710 (FIG. 7), for example. However, it will be appreciated that the method may be advantageously employed in association with multiple pizzas as illustrated in FIG. 17. At 1910, the cutting tool cutting blade edge1006 (FIG. 10) is pressed down against the pizza with pizza between the blade edge 1006 and the cutting device 700 and rotated along the slot 724, for example, bisecting the pizza, for example. A wider angled guide 710 can be utilized to more easily guide the cutting blade edge 1006 into the slot 704 and/or 724. The same method can apply to foods comprising pizza, cake, and others and it can comprise, for example, the foods utilizing containers comprising the containers/devices shown in FIGS. 13, 14, 15, 16, 17 and 18. The various cutting tools can comprise knives, cutting wheels, and the like.

At 1912 it is determined if the pizza has been cut into the proper number of slices, in other words have all of the slices been cut. If all the slices have not been cut at 1912 the method 1900 proceeds to 1914, wherein the proportional cutting device 700 is turned clockwise to the next slot 704 and/or 724, wherein the method repeats at 1910 until all of the slices have been properly bisected and the method 1900 proceeds to 1916 wherein the pizza is placed in a box for take-out or delivery or if the customers are dining in on a tray for serving. The method 1900 then ends at 1920.

Although the invention has been illustrated and described with respect to one or more embodiments, implementations, alterations, and/or modifications may be made to the illustrated examples without departing from the spirit and scope of the appended claims. In particular regard to the various functions performed by the above described components or structures (assemblies, devices, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”. “includes”, “having”, “has”, “with”, or variants thereof are used in either the detailed description and the claims, such terms are intended to be inclusive in a manner similar to the term “comprising”.

What is claimed is:

1. A food cutting device comprising:
a base having a first and second planar surface with a plurality of grooves formed in at least one of a first or a second planar surface and at least one centering groove formed on the at least one of the first or second planar surfaces; and
wherein a wider angled guide groove is formed at the end of each of the plurality of grooves;
wherein a plurality of optional cut-thru slots are fabricated in the device;
wherein the at least one centering guide is concentric about a intersection of the plurality of groves;
wherein a device material comprises food safe and/or NSF approved materials, plastic, wood and plastic composites, bamboo, wood, ash, hickory, oak, walnut, maple, purple heartwood, chestnut, cherry; plastic, porcelain, metal, stone, wood composite materials, glass, porcelain, bamboo, recycled paper composite, countertop materials, plastic composite materials, and food safe materials;
wherein the device comprises a round device, a rectangular device, and an irregular shaped device.

2. The food cutting device of claim 1, wherein the plurality of cutting grooves comprises v-grooves, compound angle cutting grooves, v-grooves, raised parallel ridges and cut-thru slots; and
wherein the foods comprise pizza, pies, cakes, tortillas and quesadillas;
wherein a cutting tool comprises a rocker type two handled knife; a pizza cutting wheel, and a knife;
wherein the device comprises at least one fixed and/or one non-fixedly attached handle.

3. The food cutting device of claim 1, wherein the device comprises cake plates, cake serving platters, plastic serving trays with covers, plastic cake pans and pie serving platters; and
wherein the materials comprising porcelain, plastic, metal, composites and polymers.

4. The food cutting device of claim 1, wherein the device is custom made based upon a customer's specifications, wherein the specification comprises a first number of a plurality of grooves formed on the first planar surface and/or a second number of a plurality of grooves formed on the second planar surface, groove dimensions, selected materials, a first number and diameter of concentric marks formed on the first planar surface and/or a second number and diameter of concentric marks formed on the second planar surface.

5. The food cutting device of claim 1, wherein the device is dishwasher safe.

6. The food cutting device of claim 1, wherein the device comprises one or more handles; and
wherein slots of other shapes and sizes including a continuous curve, various arcs, compound angles, concave shapes;
wherein the at least one centering guide comprises a continuous groove, a dashed groove, continuous mark and a continuous groove,

7. The food cutting device of claim 1, wherein the device that allows the user to cut predetermined size food items that are pie shaped, triangular, rectangular and other shaped pieces of cake, pizza, pie and other suitable foods that are not all equal slices.

8. A food cutting device comprising:
a base which has two oppositely facing first and second flat surfaces; and
wherein at least one of the flat surfaces has a plurality of grooves which intersect to subdivide the surface into a plurality of sized segments;
wherein a plurality of complete cut-thru slots is formed in the food cutting device;
wherein the at least one centering guide is concentric about an intersection of the plurality of groves;
wherein the segments comprise pie-shaped, square, rectangular and triangular shapes;
wherein the plurality of grooves are used to guide a cutting device along the grooves to cut a food item into segments;
wherein a device material comprises food safe and/or NSF approved plastic, wood and plastic composites, bamboo, wood, ash, hickory, oak, walnut, maple, purple heartwood, chestnut, cherry; plastic, porcelain, metal, stone, wood composite materials, glass, porcelain, bamboo, recycled paper composite, countertop material, plastic composite materials, and food safe materials.

9. The food cutting device of claim 8, wherein the plurality of cutting grooves facilitate cutting equal size slices and/or or varying equal slices of food; and
wherein the food comprise pizza, pies, cakes, tortillas and quesadillas.

10. The food cutting device of claim 8, wherein a trademark and/or logo is branded and/or marked comprising laser etching, hot branding and pad printing.

11. The food cutting device of claim 8, wherein the plurality of grooves formed into the device comprise, thru-cuts, compound angle cutting grooves, raised parallel ridges and various angle grooves.

12. The food cutting device of claim 8, wherein the device is custom made based upon a customer's specifications, wherein the specifications comprise a first number of a plurality of grooves formed on the first planar surface, a second number of a plurality of grooves formed on the second planar surface, a groove dimension, a selected material, a first number and diameter of concentric marks formed on the first planar surface, a second number and diameter of concentric marks formed on the second planar surface and/or thru-cuts.

13. The food cutting device of claim 8, wherein the device is dishwasher safe; and
wherein the food cutting device comprises thru-holes formed by removing material, molding the device to in a honey comb pattern to lighten the board for the end user and an aluminum honeycomb sandwiched between two layers of material

14. A method of cutting a circular pizza with a cutting device comprising;
(a) removing the pizza from an oven and placing on a proportional cutting device;
(b) centering the pizza on the cutting device by aligning the pizza with a circular slot;
(c) placing a cutting tool into a cutting device slot and moving the cutting along the slot bisecting the pizza;
(d) determining if the pizza has been cut into the proper number of slices;
(e) if the pizza has been cut into the proper number of slices go to (g) else (f);
(f) turning the cutting device clockwise or counterclockwise to the next slot;
(g) placing the pizza in a box for take-out/delivery or on a tray for dining in; and
(h) end.

15. The method of cutting a circular pizza of claim 14, wherein the device comprises cake plates, cake serving platters, plastic serving trays with covers, plastic cake pans and pie serving platters; and
wherein the materials comprising porcelain, plastic, metal, composites and polymers.

16. The method of cutting a circular pizza of claim 14, wherein the device is custom made based upon a customer's specifications, wherein the specification comprises a first number of a plurality of grooves formed on the first planar surface and/or a second number of a plurality of grooves formed on the second planar surface, groove dimensions, selected materials, a first number and diameter of concentric marks formed on the first planar surface and/or a second number and diameter of concentric marks formed on the second planar surface.

17. The method of cutting a circular pizza of claim 14, wherein the device is dishwasher safe.

18. The method of cutting a circular pizza of claim 14, wherein the device comprises one or more handles; and
wherein slots of other shapes and sizes including a continuous curve, various arcs, compound angles, concave shapes;
wherein the at least one centering guide comprises a continuous groove, a dashed groove, continuous mark and a continuous groove,

19. The method of cutting a circular pizza of claim 14, wherein the device that allows the user to cut predetermined size food items that are pie shaped, triangular, rectangular and other shaped pieces of cake, pizza, pie and other suitable foods that are not all equal slices.

20. The method of cutting a circular pizza of claim 14, wherein the device is dishwasher safe.
